(19) United States
(12) Patent Application Publication
(10) Pub. No.: US 2014/0028594 A1
(43) Pub. Date: Jan. 30, 2014

(54) TOUCH STEREOSCOPIC DISPLAY DEVICE

(71) Applicant: WINTEK CORPORATION, Taichung City (TW)

(72) Inventors: Wei-Chou Chen, Hsinchu City (TW); Yan-Yu Su, Changhua County (TW); Chong-Yang Fang, Taichung City (TW); Chia-Hsiung Chang, Tainan City (TW); Yi-Shian Chiou, Hsinchu City (TW); Cheng-Chieh Hung, Taichung City (TW)

(73) Assignee: WINTEK CORPORATION, Taichung City (TW)

(21) Appl. No.: 13/950,279

(22) Filed: Jul. 25, 2013

(30) Foreign Application Priority Data
Jul. 27, 2012 (TW) 101127202

(51) Int. Cl. G06F 3/041

(52) U.S. Cl. CPC G06F 3/041
USPC 345/173

(57) ABSTRACT

A touch stereoscopic display device includes a display panel, a touch panel, and a parallax barrier. The display panel has a display surface. The touch panel is disposed on a side of the display surface. The touch panel includes a cover lens and a touch sensing unit. The cover lens has a touch side and a non-touch side opposite to the touch side. The non-touch side faces the display panel. The touch sensing unit is disposed on the non-touch side of the cover lens. The parallax barrier is disposed in the touch panel, and the parallax barrier is used to generate a barrier stereoscopic display effect. The parallax barrier is disposed on the non-touch side of the cover lens.

### BACKGROUND OF THE INVENTION

1. Field of the Invention

The present invention generally relates to the field of display devices with touch function and three dimensional display effects, and more particularly, to a touch stereoscopic display device with a simplified structure.

2. Description of the Prior Art

Recently, one of the mainstream development trends in the display field is to apply touch function and three-dimensional (3D) display effects to display devices. As shown in FIG. 1, a conventional touch stereoscopic display 100 usually includes a display panel 110, a passive type stereoscopic display device 132 and a touch panel 120. The passive type stereoscopic display unit 132 may include either a parallax barrier or a lenticular lens disposed on a first substrate 131. A first adhesive layer 141 may be applied so that the first substrate 131 can be adhered to a display surface 110S of the display panel 110. In addition, a second adhesive layer 142 may be applied to have the first substrate 131 adhered to the touch panel 120. As a result, the conventional touch stereoscopic display 100 can show a 3D display effects by combining the display panel 110 and the passive type stereoscopic display unit 132 and can provide required touch function by the touch panel 120. Furthermore, the touch function may be incorporated with the images shown by the display panel 110 so as to provide an intuitive interface in the touch stereoscopic display 100.

In the touch panel 120, a second substrate 121 having a touch sensing unit 122 is usually adhered to the cover glass 124 through a third adhesive layer 123. In this way, a surface 124S of the cover glass 124 opposite to the third adhesive layer 123 can be served as a touching surface. However, except for the display panel 110, this configuration still needs three substrates (the first substrate 131, the second substrate 121 and the cover glass 124) and three corresponding adhesive layers, which results many drawbacks, such as heavy weight, relatively high manufacturing costs, complex structure, and complex manufacturing processes.

### SUMMARY OF THE INVENTION

One objective of the present invention is to provide a touch stereoscopic display device where a touch sensing unit and a parallax barrier used to show 3D display effects are integrated on a cover lens and combined with a display panel so that a touch stereoscopic display device with a simplified structure, relatively low manufacturing costs and relatively thin form can be obtained.

To this end, a touch stereoscopic display device is provided according to one preferred embodiment of the present invention. The touch stereoscopic display device includes a display panel, a touch panel and a parallax barrier. The display panel has a display surface. The touch panel is disposed on a side of the display surface. The touch panel includes a cover lens and a touch sensing unit. The cover lens has a touch side and a non-touch side opposite to the touch side. The non-touch side faces the display panel. The touch sensing unit is disposed on the non-touch side of the cover lens. The parallax barrier is disposed in the touch panel, and the parallax barrier is used to generate a barrier stereoscopic display effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional diagram showing a structure of conventional touch stereoscopic display.

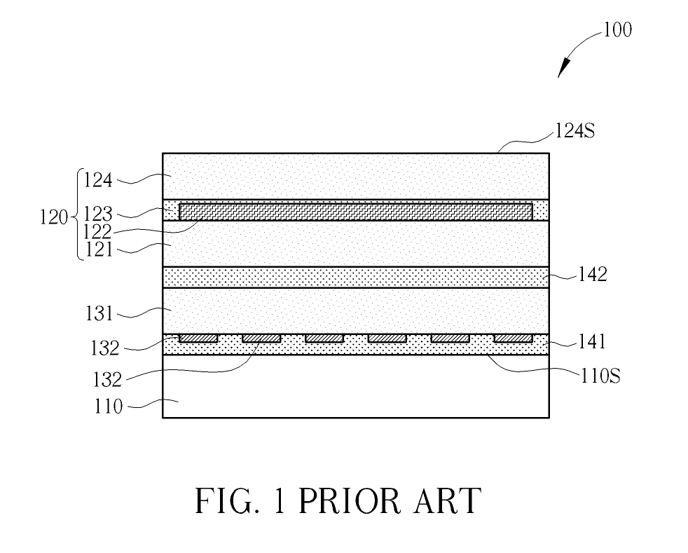

FIG. 2 is a schematic cross-sectional diagram showing a touch stereoscopic display device according to a first preferred embodiment of the present invention.

FIG. 3 is a schematic top view showing a touch stereoscopic display device according to a first preferred embodiment of the present invention.

FIG. 4 is a schematic diagram showing a touch stereoscopic display device operated in a display state according to a first preferred embodiment of the present invention.

FIG. 5 is a schematic top view showing a touch stereoscopic display device according to a second preferred embodiment of the present invention.

FIG. 6 is a schematic top view showing a touch stereoscopic display device according to a third preferred embodiment of the present invention.

FIG. 7 is a schematic top view showing a touch stereoscopic display device according to a fourth preferred embodiment of the present invention.

### DETAILED DESCRIPTION

In the following description, numerous specific details are given to provide a thorough understanding of the invention. It will, however, be apparent to one skilled in the art that the invention may be practiced without these specific details. Furthermore, some well-known system configurations and process steps are not disclosed in detail, as these should be well-known to those skilled in the art.

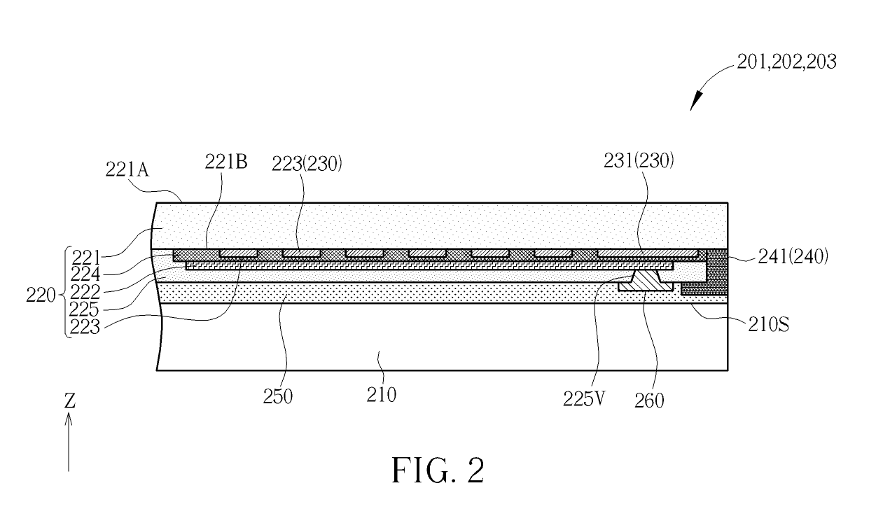

As shown in FIG. 2, a touch stereoscopic display device 201 is provided according to a first preferred embodiment of the present invention. The touch stereoscopic display device 201 includes a display panel 210, a touch panel 220, and a parallax barrier 223. The display panel 210 has a display surface 210S. The touch panel 220 is disposed on a side of the display surface 210S. The touch panel 220 includes a cover lens 221 and a touch sensing unit 222. The cover lens 221 has a touch side 221A and a non-touch side 221B opposite to the touch side 221A. The non-touch side 221B faces the display panel 210. To put it more concretely, the parallax barrier 223 may be formed on a non-touch side 221B of the cover lens 221 and the planarization layer 224 is then formed to cover the parallax barrier 223 and at least a portion of the cover lens 221. The touch sensing unit 222 is finally formed on the planarization layer 224, but not limited thereto. For example, the relative positions of the touch sensing unit 222 and the parallax barrier 223 within the touch panel 220 can be adjusted according to various requirements, and the planarization layer 224 can be omitted if required. Additionally, the touch stereoscopic display device 201 further includes an adhesive layer 250 disposed between the display panel 210 and the touch panel 220 for combining the display panel 210 and the touch panel 220. Since the parallax barrier 223 is disposed in the touch panel 220 and both the parallax barrier 223 and the touch sensing unit 222 are disposed on the cover lens 221, the touch stereoscopic display device 201 in this embodiment can has a simplified structure and a relatively thin form accordingly.

As shown in FIG. 2, the touch stereoscopic display device 201 disclosed in this embodiment may further include a decoration layer 231, a protective layer 225 and a light-shielding layer 241. The protective layer 225 is disposed between the touch sensing unit 222 and the adhesive layer 250 in order to protect the touch sensing unit 222. The protective layer 225 may preferably include at least one opening 225V partially exposing the touch sensing unit 222. A control unit 260, like drive circuit, may be electrically connected to the touch sensing unit 222 through the opening 225V, but not limited thereto. The decoration layer 231 is disposed on the cover lens 221. It is worth noting that, the parallax barrier 223 and the decoration layer 231 preferably are made of a same decoration material 230 in order to further reduce the complexity of the manufacturing processes, but not limited thereto. Furthermore, the light-shielding layer 241 is preferably made of a light-shielding material 240 and formed on the edge of the touch panel 220 so that a frame of the touch panel 220 can be decorated and the appearance of the corresponding product can be beautified.

The display panel 210 disclosed in the present embodiment preferably includes a liquid display panel, an organic light emitting diode (OLED) display panel, an electro-wetting display panel, an e-ink display panel, a plasma display panel or a field emission display (FED) panel, but not limited thereto. The planarization layer 224 and the protective layer 225 may preferably include inorganic material or organic material. For example, the inorganic material may include silicon nitride, silicon oxide and silicon oxynitride, while the organic material may include acrylic resin or other suitable material. In addition, preferably, the above-mentioned decoration material 230 and the light-shielding material 240 may respectively include dye-resin, dye ink, metal or other suitable dark opaque material, but not limited thereto. The cover lens 221 disclosed in this embodiment preferably include rigid cover lens, such as cover glass or flexible cover lens, such as plastic cover lens, or other cover lenses made of suitable materials.

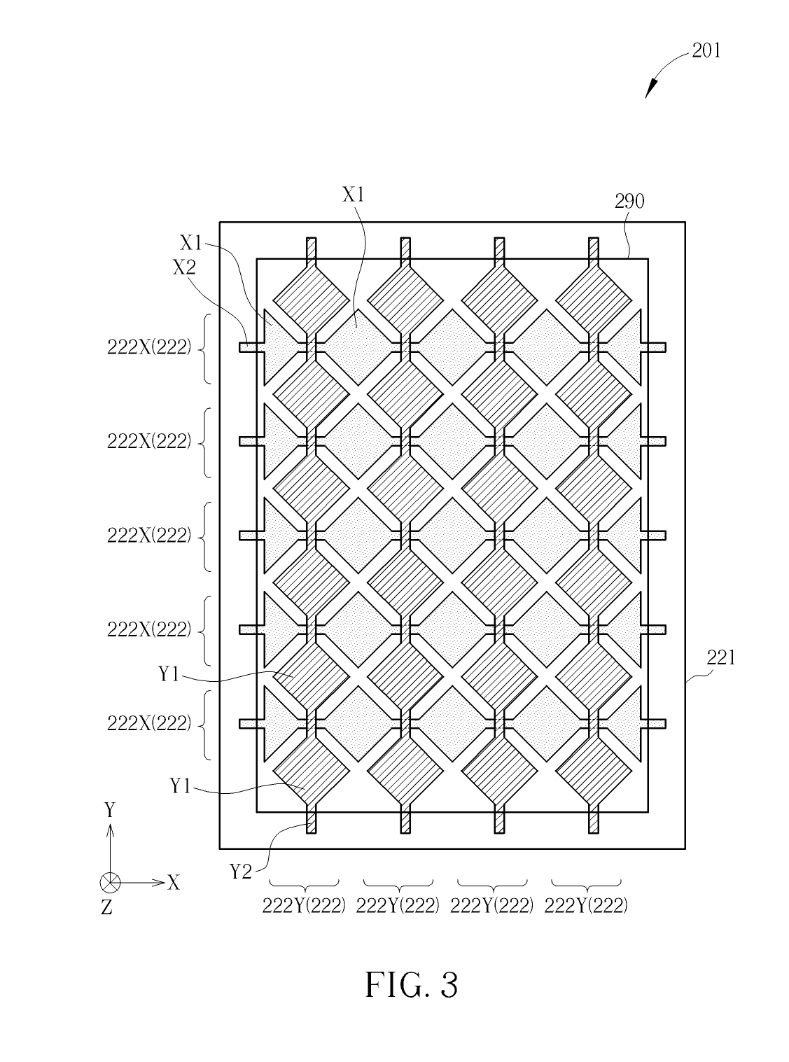

As shown in FIG. 3, the touch sensing unit 222 disclosed in this embodiment preferably includes a plurality of first axis electrodes 222X and a plurality of second axis electrodes 222Y disposed across from one another. Each first axis electrode 222X extends along a first direction X and each second axis electrode 222Y extends along a second direction Y. Besides, the first direction X is preferably substantially perpendicular to the second direction Y, but not limited thereto. Each first axis electrode 222X includes a plurality of first sensing electrodes X1 disposed within a touch region 290, and each second axis electrode 222Y includes a plurality of second sensing electrodes Y1 disposed within the touch region 290. Each first axis electrode 222X and each second axis electrode 222X may respectively further include a plurality of first conductive lines X2 and a plurality of second conductive lines Y2. The function of the first conductive lines X2 and the second conductive lines Y2 is to respectively electrically connect the first sensing electrodes X1 in the same first axis electrode 222X and electrically connect the second sensing electrodes Y1 in the same second axis electrode 222Y. Preferably, the first conductive lines X2 and the second conductive lines Y2 extend outside the touch region 290 so that they can electrically connect to a control unit (not shown in FIG. 3), but not limited thereto.

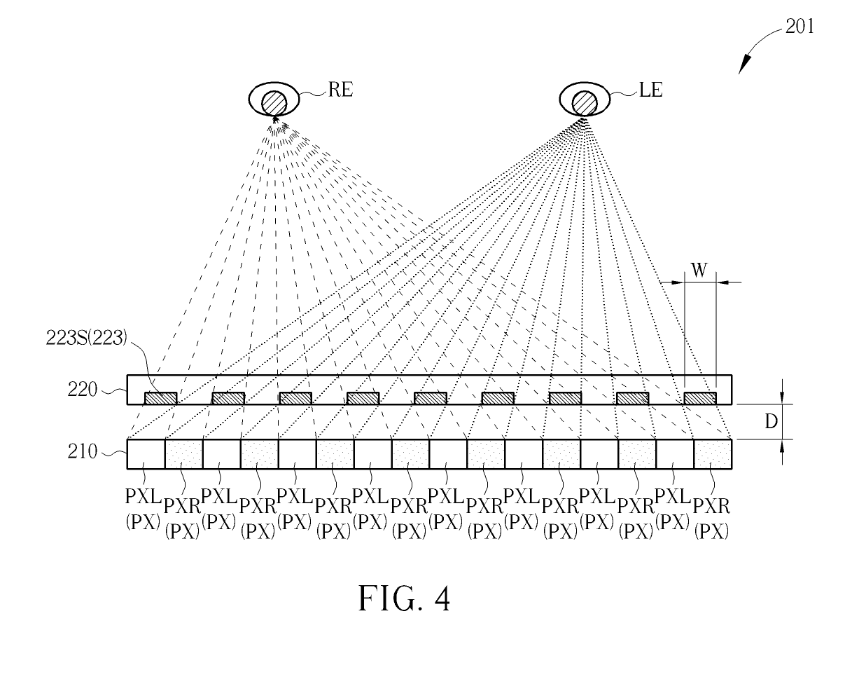

In order to further clarify a 3D display condition of the touch stereoscopic display device 201, the relevant diagram is depicted in FIG. 4. Please refer to FIG. 4 accompanied with FIG. 2. In the touch stereoscopic display device 201, the display panel 210 may include a plurality of pixels PX. For example, the display panel 210 may preferably include a plurality of first pixels PXL and a plurality of second pixels PXR. In a 3D display mode, each of the first pixels PXL may be used to provide a display image supposed to be received by a left-eye LE of a viewer, while each of the second pixels PXR may be used to provide another display image supposed to be received by a right-eye RE of the viewer. By controlling the display images provided by each of the first pixels PXL and each of the second pixels PXR respectively and configuring the parallax barrier 223 in the touch panel 220, the left-eye LE of the viewer can only receive the display images provided by each of the first pixels PXL, that is to say, the display images provided by each of the second pixels PXR can not be received by the right-eye RE of the viewer. Similarly, the right-eye RE of the viewer can only receive the display images provided by each of the second pixels PXR and the display images provided by each of the first pixels PXL can not be received by the left-eye LE of the viewer. As a result, 3D display effects can be provided by this naked-type display device configured with the parallax barrier. It is worth noting that the parallax barrier 223 disclosed in this embodiment may include a plurality of stripe barriers 223S, a width W of each of the stripe barriers 223S can be adjusted depending on a distance D between the display panel 210 and the touch panel 220 and depending on a size of each pixel PX. By the way of example, when the distance D between the display panel 210 and the touch panel 220 becomes farther, the width W of each of the stripe barriers 223S can be correspondingly decreased in order to achieve required parallax barrier effects. It should be noted that each of the first pixels PXL and each of the second pixels PXR may also be used to optionally provide two-dimensional (2D) images. In this way, a portion of or the entire display region the touch stereoscopic display device 201 can provide either 2D or 3D display effects. Furthermore, the 2D or 3D display effects may be switchable in the touch stereoscopic display device 201.

In the following paragraph, various embodiments about touch stereoscopic display devices are disclosed and the description below is mainly focused on differences among each embodiment. In addition, like or similar features will usually be described with same reference numerals for ease of illustration and description thereof.

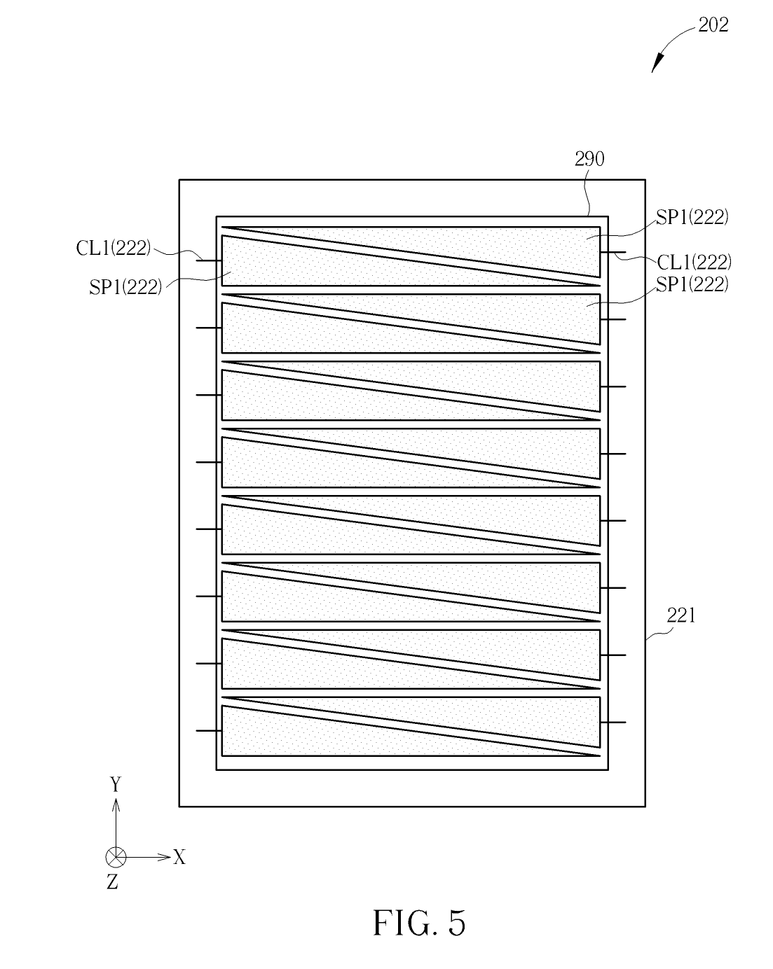

As shown in FIG. 5 and FIG. 2, a touch stereoscopic display device 202 is provided according to a second preferred embodiment of the present invention. One main difference between the first preferred embodiment and the present embodiment is that the touch sensing unit 222 disposed in the touch stereoscopic display device 202 preferably includes a plurality of sensing electrodes SP1. These sensing electrodes SP1 are separately disposed within the touch region 290 in order carry out touch sensing abilities. Additionally, the touch sensing unit 222 may further include a plurality of conductive lines CL1 respectively connected to each sensing electrode SP1. Preferably, each conductive line CL1 may extend outside the touch region 290 for being electrically connected to a control unit (not shown in FIGS. 2 and 5), but not limited thereto. Apart from the existence of the sensing electrodes SP1, the rest of the parts in the touch stereoscopic display device 202 disclosed in this embodiment, as well as the characteristics of other parts, disposed positions, material properties and stereoscopic display effects are almost similar to those described in the previous preferred embodiment. For the sake of brevity, these similar configurations and properties are therefore not disclosed in detail. It is worth noting that each of the sensing electrodes SP1 disclosed in the present embodiment is preferably has a triangular shape, but not limited thereto. That is to say, each sensing electrodes SP1 can be in shapes other than triangular shape and the sensing electrodes SP1 can be uniformly distributed within the touch region 290 so as to achieve required touch sensing abilities.

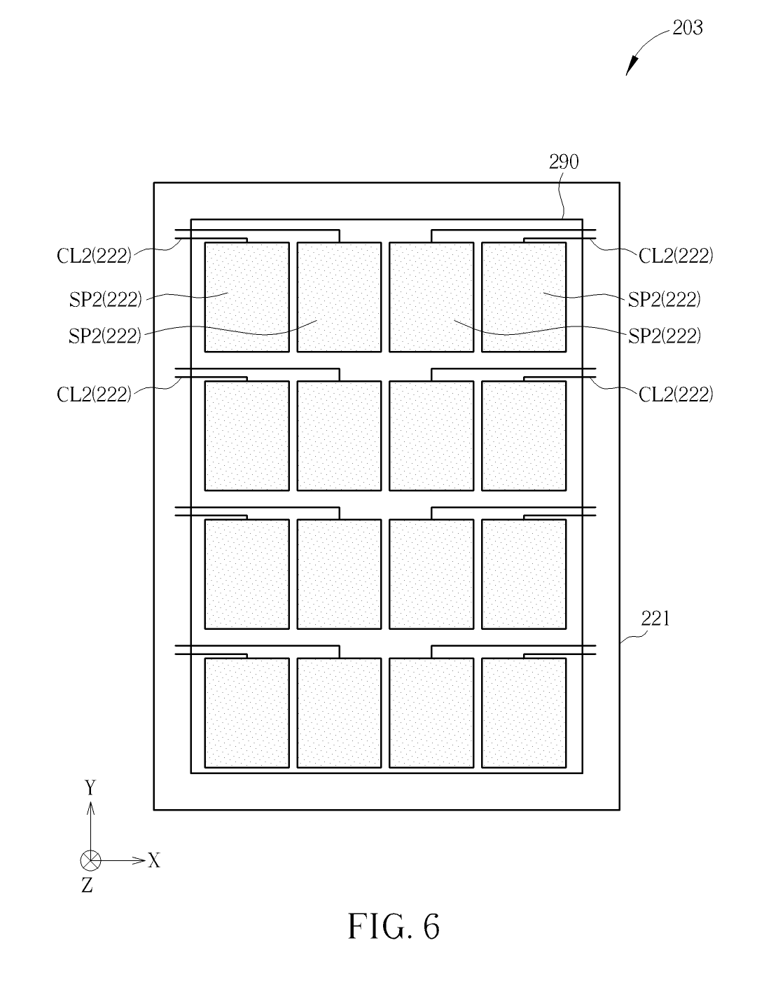

As shown in FIG. 6 and FIG. 2, a touch stereoscopic display device 203 is provided according to a third preferred embodiment of the present invention. According to the present embodiment, a touch sensing unit 222 disposed in the touch stereoscopic display device 203 preferably includes a plurality of sensing electrodes SP2. These sensing electrodes SP2 are separately disposed within the touch region 290 and have touch sensing abilities. Additionally, the touch sensing unit 222 may further include a plurality of conductive lines CL2 respectively connected to each sensing electrode SP2. Preferably, each conductive line CL2 may extend outside the touch region 290 for being electrically connected to a control unit (not shown in FIGS. 2 and 6), but not limited thereto. It is worth noting that each of the sensing electrodes SP2 disclosed in the present embodiment is preferably has a rectangular shape, but not limited thereto. That is to say, sensing electrodes SP2 can be in other shapes like regular or irregular shapes and the sensing electrodes SP2 can be uniformly distributed within the touch region 290 so as to achieve required touch sensing abilities.

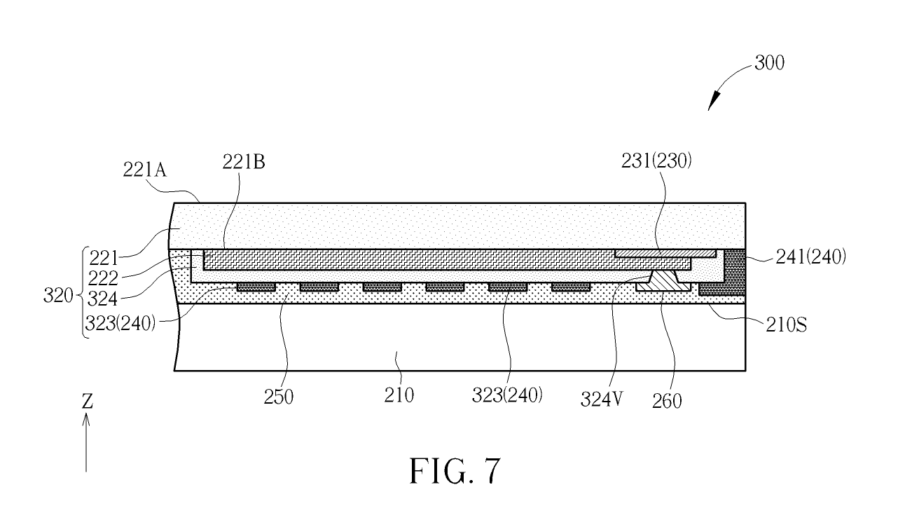

As shown in FIG. 7, a touch stereoscopic display device 300 is provided according to a fourth preferred embodiment of the present invention. The touch stereoscopic display device 300 includes a display panel 210, a touch panel 320 and a parallax barrier 323. One main difference between the first preferred embodiment and this embodiment is that the touch panel 320 disclosed in this embodiment includes a planarization layer 324 disposed between the parallax barrier 323 and the touch sensing unit 222. In addition, the parallax barrier 323, the planarization layer 324 and the touch sensing unit 222 are stacked with one another along a direction Z perpendicular to the cover lens 221. In other words, the touch sensing unit 222, the planarization layer 324 and the parallax barrier 323 may be formed sequentially. To put it more concretely, the touch sensing unit 222 may be formed on the cover lens 221 and the planarization layer 324 is then formed to cover the touch sensing unit 222. The parallax barrier 323 is finally formed on the planarization layer 324, but not limited thereto. For example, the relative positions of the sensing unit 222 and the parallax barrier 323 within the touch panel 320 can be adjusted according to various requirements. Furthermore, the planarization layer 324 disclosed in this embodiment may preferably include at least an opening 324V partially exposing the touch sensing unit 222. A control unit 260 may be electrically connected to the touch sensing unit 222 through the opening 324V, but not limited thereto. Apart from the relative positions between the parallax barrier 323 and the touch sensing unit 222, the rest of the parts in the touch stereoscopic display device 300 disclosed in this embodiment, as well as the characteristics of other parts, disposed positions, material properties and stereoscopic display effects are almost similar to those described in the previous preferred embodiment. For the sake of brevity, these similar configurations and properties are therefore not disclosed in detail. It is worth noting that, since the parallax barrier 323 and the light-shielding layer 241 preferably are made of the same light-shielding material 240, the corresponding manufacturing processes can be therefore further simplified, but not limited thereto.

In summary, the present invention provides a touch stereoscopic display device where a touch sensing unit and a parallax barrier used to show stereoscopic display effects are integrated on a cover lens so that a touch stereoscopic display device with a simplified structure, relative low manufacturing costs and relatively thin form can be obtained.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch stereoscopic display device, comprising:
a display panel, having a display surface;
a touch panel, disposed on a side of the display panel, wherein the touch panel comprises:
a cover lens, having a touch side and a non-touch side opposite to the touch side, wherein the non-touch side faces the display panel; and
a touch sensing unit, disposed on the non-touch side of the cover lens; and
a parallax barrier, disposed in the touch panel and being used to generate a barrier stereoscopic display effect, wherein the parallax barrier is disposed on the non-touch side of the cover lens.

2. The touch stereoscopic display device according to claim 1, wherein the touch panel further comprises a planarization layer disposed between the parallax barrier and the touch sensing unit, and the parallax barrier, the planarization layer and the touch sensing unit are stacked with one another along a direction perpendicular to the cover lens.

3. The touch stereoscopic display device according to claim 2, wherein the planarization layer directly contacts with the parallax barrier and the touch sensing unit.

4. The touch stereoscopic display device according to claim 2, wherein the parallax barrier is disposed between the planarization layer and the cover lens, and the touch sensing unit is disposed between the planarization layer and the display panel.

5. The touch stereoscopic display device according to claim 2, wherein the touch sensing unit is disposed between the planarization layer and the cover lens, and the parallax barrier is disposed between the planarization layer and the display panel.

6. The touch stereoscopic display device according to claim 1, wherein the touch panel further comprises a decoration layer disposed on the cover lens, and the parallax barrier and the decoration layer are made of a same decoration material.

7. The touch stereoscopic display device according to claim 1, wherein the touch panel further comprises a light-shielding layer disposed between the cover lens and the display panel, and the parallax barrier and the light-shielding layer are made of a same light-shielding material.

8. The touch stereoscopic display device according to claim 1, wherein the touch sensing unit comprises a plurality of first axis electrodes and a plurality of second axis electrodes disposed across from one another.

9. The touch stereoscopic display device according to claim 1, wherein the touch sensing unit comprises a plurality of sensing electrode disposed separately from one another.

10. The touch stereoscopic display device according to claim 1, further comprising an adhesive layer disposed between the display panel and the touch panel, wherein the display panel is adhered to the touch panel by the adhesive layer.

11. The touch stereoscopic display device according to claim 1, wherein the display panel comprises a liquid display panel, an organic light emitting diode (OLED) display panel, an electro-wetting display panel, an e-ink display panel, a plasma display panel or a field emission display (FED) panel.
